(19) United States
(12) Patent Application Publication
(10) Pub. No.: US 2026/0336177 A1
(43) Pub. Date: Oct. 29, 2026

(54) MOLDING MANAGEMENT SYSTEM

(71) Applicant: SEIKO EPSON CORPORATION, Tokyo (JP)

(72) Inventors: Atsushi HAIZUKA, SHIOJIRI-SHI (JP); Kosuke ATSUTA, SHIOJIRI-SHI (JP); Satoshi YAMAZAKI, MATSUMOTO-SHI (JP); Shigeru YAMAZAKI, SHIOJIRI-SHI (JP)

(21) Appl. No.: 19/659,859

(22) Filed: Apr. 27, 2026

(30) Foreign Application Priority Data
Apr. 28, 2025 (JP) 2025-074229

(51) Int. Cl. B29C 45/76

(52) U.S. Cl. CPC B29C 45/76; B29C 2945/76936; B29C 2945/76943; B29C 2945/76949

(57) ABSTRACT

A molding management system includes an information processing device, and when a predetermined trigger condition is satisfied, the information processing device excludes output data that satisfies an exclusion condition from one or more pieces of the output data acquired from an injection molding apparatus, calculates a response surface with a measurement value of each of one or more management items among one or more measurement values as a response variable and an injection molding condition as an explanatory variable based on the output data remaining without being excluded among the one or more pieces of output data, and changes the injection molding condition set in the injection molding apparatus based on the calculated response surface.

The present application is based on, and claims priority from JP Application Serial Number 2025-074229, filed Apr. 28, 2025, the disclosure of which is hereby incorporated by reference herein in its entirety.

### BACKGROUND

### Technical Field

The present disclosure relates to a molding management system.

### Related Art

Technologies for managing production of products in a production process including an injection molding step of the products by an injection molding apparatus are being developed.

In this regard, there is known a technique of updating an adjustment gain for an injection molding apparatus to control a management item so that a measurement value of the management item is closer to a target value based on a known correlation between an injection molding condition and the management item which is a parameter correlated with the quality of a product among parameters measurable in the injection molding apparatus and a peripheral device of the injection molding apparatus when a mold, a material used for injection molding of the product, an environment around the injection molding apparatus, or the like changes (see JP-A-2022-104268). However, in JP-A-2022-104268, the adjustment gain is not necessarily gain for directly controlling the management item itself, and may be gain for controlling a parameter strongly correlated with the management item among parameters controlled in the injection molding apparatus.

JP-A-2022-104268 is an example of the related art.

Here, it is known that the technique as described in JP-A-2022-104268 requires that the correlation between the management item and the injection molding condition should be known in advance, and is applicable only when the correlation is a simple relationship. In order to solve this problem, there is known a method of calculating a response surface having a management item as a response variable and an injection molding condition as an explanatory variable based on cycle data acquired from an injection molding apparatus moment by moment using a model of machine learning or the like, and updating the injection molding condition based on the calculated response surface. However, in the method, the response surface is often calculated based on data including a measurement value deviating from the actual correlation between the management item and the injection molding condition, such as an outlier obtained when the injection molding by the injection molding apparatus is not stable. Thus calculated response surface may not correctly express the correlation between the management item and the injection molding condition. This may make it difficult to obtain a desired injection molding condition, which is not desirable.

### SUMMARY

A molding management system according to an aspect of the present disclosure is a molding management system including an information processing device communicably coupled to a terminal device for management of production of a product in a production process including an injection molding step of the product by an injection molding apparatus, wherein the information processing device acquires output data output from the injection molding apparatus for each cycle of injection molding performed by the injection molding apparatus, the output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus, the one or more measurement values include a measurement value for each of one or more management items correlated with quality of the product, and when a predetermined trigger condition is satisfied, the information processing device excludes the output data that satisfies a predetermined exclusion condition from one or more pieces of the output data acquired from the injection molding apparatus, calculates a response surface with the measurement value of each of the one or more management items among the one or more measurement values as a response variable and the injection molding condition as an explanatory variable based on the output data remaining without being excluded among the one or more pieces of the output data, and changes the injection molding condition set in the injection molding apparatus based on the calculated response surface.

### BRIEF DESCRIPTION OF THE DRAWINGS

FIG. 1 shows an example of a configuration of a molding management system 1.

FIG. 2 is an image diagram of a flow in which quality of a product injection-molded by an injection molding apparatus changes when an injection molding condition is changed.

FIG. 3 is an image diagram showing a flow until an injection molding condition is generated from a response surface.

FIG. 4 shows an example of a hardware configuration of an information processing device 20.

FIG. 5 shows an example of a functional configuration of the information processing device 20.

FIG. 6 shows an example of a flow of processing of setting an injection molding condition in the injection molding apparatus by the information processing device 20.

FIG. 7 shows an example of a flow of processing of causing the injection molding apparatus to perform injection molding by the information processing device 20.

FIG. 8 shows an example of the flow of injection molding condition change processing executed in step S240 shown in FIG. 7.

FIG. 9 shows an example of an exclusion condition reception image for designating one or more pieces of output data to be excluded by a user.

FIG. 10 is a schematic diagram showing an image of processing performed by the information processing device 20 in continuous execution of a cycle at a number of cycle executions by the injection molding apparatus.

FIG. 11 shows an example of a flow of processing of generating an injection molding condition to be first set in the injection molding apparatus by the information processing device 20.

### DESCRIPTION OF EMBODIMENTS

### Embodiments

Embodiments of the present disclosure will be described below with reference to the drawings.

### Overview of Molding Management System

First, an overview of a molding management system according to the embodiment will be described.

A molding management system according to an embodiment manages production of a product in a production process including an injection molding step of the product by an injection molding apparatus. The molding management system includes an information processing device. The information processing device is communicably coupled to a terminal device. Here, the information processing device acquires output data output from the injection molding apparatus for each cycle of injection molding performed by the injection molding apparatus. The output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus. The one or more measurement values include a measurement value for each of one or more management items correlated with the quality of the product. When a predetermined trigger condition is satisfied, the information processing device excludes output data that satisfies a predetermined exclusion condition from the one or more pieces of output data acquired from the injection molding apparatus. Furthermore, the information processing device calculates a response surface having a measurement value for each of the one or more management items among the one or more measurement values as a response variable and an injection molding condition as an explanatory variable based on the output data remaining without being excluded among the one or more pieces of output data, and changes the injection molding condition set in the injection molding apparatus based on the calculated response surface. Accordingly, the molding management system can cause the injection molding apparatus to mold a high-quality product even when the correlation between the management item and the injection molding condition is unknown and complicated.

In the following description, a configuration of the molding management system according to the embodiments and processing performed by a server provided in the molding management system will be described in detail.

### Configuration of Molding Management System

Hereinafter, the configuration of the molding management system according to the embodiments will be described by taking the molding management system 1 as an example.

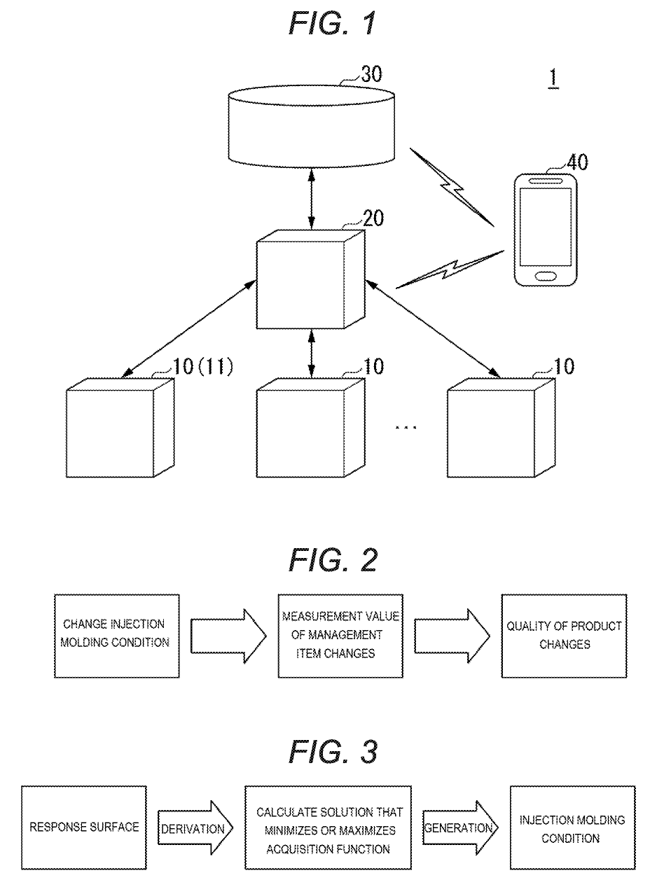

FIG. 1 shows an example of a configuration of the molding management system 1.

The molding management system 1 is a type of manufacturing execution system (MES). For example, the molding management system 1 includes one or more managed devices 10, an information processing device 20, and a server 30. The molding management system 1 may be configured not to include some or all of the one or more managed devices 10. The molding management system 1 may include the server 30 without including the information processing device 20. The molding management system 1 may include the information processing device 20 without including the server 30. In the molding management system 1, the information processing device 20 may be configured integrally with the server 30. Hereinafter, as an example, a case where the molding management system 1 includes a plurality of managed devices 10 as the one or more managed devices 10 will be described. Furthermore, hereinafter, as an example, a case where the molding management system 1 includes both the information processing device 20 and the server 30 separate from the information processing device 20 will be described. The information processing device 20 is an example of an information processing device.

Each of the plurality of managed devices 10 provided in the molding management system 1 is a device managed by the molding management system 1. In FIG. 1, for convenience of description, the plurality of managed devices 10 are indicated by the same sign. However, some or all of the plurality of managed devices 10 may be devices of types different from one another. The plurality of managed devices 10 include at least one injection molding apparatus that performs injection molding of a product using resin such as plastic. An injection molding apparatus 11 shown in FIG. 1 is an example of the injection molding apparatus. The plurality of managed devices 10 may include an injection molding apparatus that performs metal injection molding (MIM) of a product. Hereinafter, for convenience of description, injection molding of a product using resin such as plastic is simply referred to as injection molding. Furthermore, hereinafter, the injection molding apparatus that performs the injection molding of a product using resin such as plastic is simply referred to as an injection molding apparatus. At least one injection molding apparatus in the plurality of managed devices 10 may be a device that performs injection molding using a material other than resin and metal. In addition to the injection molding apparatus, the plurality of managed devices 10 include, for example, peripheral equipment of the injection molding apparatus. Examples of the peripheral equipment of the injection molding apparatus include, but are not limited to, a material supply device, a conveying device, a cleaning device, and a sintering device. Here, the material supply device is a device that supplies a material used for injection molding of a product by the injection molding apparatus to the injection molding apparatus. The conveying device is a device that conveys a product injection-molded by the injection molding apparatus. The cleaning device is a device that cleans a product injection-molded by the injection molding apparatus. The sintering device is a device that sinters a product after being cleaned by the cleaning device.

The molding management system 1 manages production of a product in a production process including an injection molding step of the product performed by the injection molding apparatus in the plurality of managed devices 10. Here, the injection molding apparatus in the plurality of managed devices 10 may have any configuration as long as the configuration is capable of producing a product by injection molding. Hereinafter, for convenience of description, a step in which the injection molding apparatus performs injection molding of a product once is referred to as a cycle. Furthermore, hereinafter, for convenience of description, a hollow in a mold attached to the injection molding apparatus is referred to as a cavity. That is, the injection molding apparatus performs injection molding of a product by injecting a material into the cavity in the mold attached to the injection molding apparatus and applying a pressure to the material in the cavity.

Here, one or more injection molding apparatuses in the plurality of managed devices 10 each include an extrusion unit that extrudes, in the injection molding step, a material used for injection molding of the product into the cavity in the mold attached to the injection molding apparatus. The extrusion unit is, for example, a screw that moves a position in a cylinder back and forth by rotating in the cylinder. Instead of the screw, the extrusion unit may be a member that moves the position in the cylinder back and forth by a hydraulic pressure, a linear actuator, or the like. The material is extruded from an injection port of the cylinder toward the cavity in the mold in response to advance of the extrusion unit in the cylinder. Hereinafter, for convenience of description, the extrusion unit provided in the injection molding apparatus is referred to as the screw.

One or more measurement units are attached to the one or more injection molding apparatuses in the plurality of managed devices 10. The one or more measurement units measure various measurable parameters that can be measured in the injection molding apparatus in each cycle. The measurable parameters include, but are not limited to, for example, some or all of a position of the screw, an injection speed as a speed at which the material is injected into the cavity in the mold by the screw, a rotation speed of the screw, an injection holding pressure as a pressure in the mold held by the screw, and a temperature in the mold. The measurable parameters include a parameter by which a target value can be set in the injection molding apparatus. In other words, the measurable parameters include parameters that can be controlled by the injection molding apparatus. Therefore, hereinafter, for convenience of description, a parameter by which a target value can be set in the injection molding apparatus among the measurable parameters will be referred to as a settable parameter. Here, when a target value is set in the injection molding apparatus for a certain settable parameter, the injection molding apparatus controls the settable parameter such that a measurement value of the settable parameter is closer to the target value during execution of the cycle. Therefore, hereinafter, for convenience of description, among the settable parameters, a settable parameter for which one or more target values are set in the injection molding apparatus will be described as a control parameter. Furthermore, hereinafter, for convenience of description, one or more target values for each control parameter will be collectively referred to as an injection molding condition. This is because the injection molding apparatus performs injection molding by controlling the control parameter, and when the target value of the control parameter is changed, the quality of the product injection-molded by the injection molding apparatus changes. Note that a measurement value measured by a certain measurement unit may be referred to as an actual value.

Here, a measurement unit that measures a certain measurement value among one or more measurement units attached to a certain injection molding apparatus includes, but is not limited to, for example, a sensor that measures the measurement value. The one or more measurement units may include a measurement unit that measures the quality of a product. This is because the quality of the product is also controlled by the injection molding apparatus in each cycle. In this case, the measurement unit includes, but is not limited to, for example, a device that includes an imaging unit capable of imaging the product to measure the quality of the product. In this case, for example, a quantity indicating the quality of the product measured by the measurement unit includes, but is not limited to, for example, one of a plurality of predetermined values arranged in descending order of quality. The one or more measurement units may include an input unit to which a measurement value measured manually is input. The measurement value includes, but is not limited to, for example, a dimension measured by a user using a caliper, a micrometer, or the like. The input unit may be a graphical user interface (GUI) displayed on a multifunctional mobile phone terminal (smartphone), a personal digital assistant (PDA), or the like, may be a part of the injection molding apparatus, or may be another device capable of outputting an input measurement value to the injection molding apparatus. The input unit may be a measurement device such as a digital caliper or a digital micrometer capable of outputting a measured length to the injection molding apparatus.

The information processing device 20 selects each of one or more settable parameters desired by the user from among one or more settable parameters as a management item according to the received operation. The management item is a settable parameter selected by the user as a settable parameter correlated with the quality of the product to be injection-molded by the injection molding apparatus. In other words, the management item is a settable parameter that the user wishes to manage to maintain the quality of the product. Therefore, the measurable parameters having the measurement value that can be measured in the injection molding apparatus include the settable parameter by which the target value can be set. The settable parameters include a control parameter in which a target value is actually set as an injection molding condition and a management item managed by the user. In a Venn diagram, a part of the set of control parameters may overlap a part of the set of management items. That is, some of the control parameters can also be selected as management items. The management item may be referred to as a management parameter. In addition, a target value as a target to which the measurement value is indirectly brought close by the control of the control parameter is assigned to the management item that is not the control parameter. However, the target value is not a target value in the control of the management item, that is, a value set in the injection molding apparatus as an injection molding condition. The target value of the management item that is not the control parameter is a value simply used in the management of the management item.

The information processing device 20 acquires the cycle data for each cycle from each of the one or more injection molding apparatuses in the plurality of managed devices 10. More specifically, the information processing device 20 acquires the cycle data from each of the one or more injection molding apparatuses at each time when each cycle ends. Hereinafter, for convenience of description, the cycle data acquired when a certain cycle ends is referred to as cycle data of the cycle. Further, hereinafter, for convenience of description, a cycle that ends when certain cycle data is acquired is referred to as a cycle of the cycle data.

The cycle data of a certain cycle is information including one or more pieces of cycle-related information obtained as a result of execution of the cycle by the injection molding apparatus that is an acquisition source of the cycle data, apparatus identification information for identifying the injection molding apparatus, and first date-and-time information indicating date and time when the cycle data is acquired from the injection molding apparatus by the information processing device 20. The apparatus identification information is, for example, an identifier (ID) for identifying the injection molding apparatus, and may be other information through which the injection molding apparatus can be identified, such as an Internet protocol (IP) address assigned to the injection molding apparatus. The first date-and-time information may be a time stamp or other information indicating the date and time. The cycle data may include other information in addition to the one or more pieces of cycle-related information, the apparatus identification information, and the first date-and-time information. The apparatus identification information may be contained in the cycle data as one of the one or more pieces of cycle-related information. Hereinafter, as an example, a case where the apparatus identification information is contained in the cycle data as one of the one or more pieces of cycle-related information will be described.

The one or more pieces of cycle-related information contained in cycle data of a certain cycle include one or more pieces of measurement value information in addition to apparatus identification information for identifying the injection molding apparatus as an acquisition source of the cycle data. Each of the one or more pieces of measurement value information is information indicating a measurement value measured by each of the one or more measurement units in the injection molding apparatus. That is, the one or more pieces of cycle-related information include measurement value information such as measurement value information indicating the measurement value of the control parameter and measurement value information indicating the measurement value of the management item. The one or more pieces of measurement value information contained in the one or more pieces of cycle-related information include measurement value information indicating a measurement value continuously measured during execution of the cycle by the injection molding apparatus in addition to measurement value information indicating a measurement value obtained as a result of measurement performed only once during execution of the cycle by the injection molding apparatus. Hereinafter, for convenience of description, the measurement value will be referred to as a time-series measurement value. The measurement value information indicating the time-series measurement value includes time-series information indicating a time series of the time-series measurement value and feature value information indicating one or more types of feature values for the time-series measurement value. Here, the one or more types of feature values for a certain time-series measurement value are, for example, at least one of a minimum value, a maximum value, an average value, a variance, and a standard deviation of the time-series measurement value, a start value of a period in which the time-series measurement value is measured, and an end value of the period. That is, the one or more types of feature values are values indicating features of a waveform indicating a temporal change in the time-series measurement value. The one or more types of feature values may include another value obtained by statistical processing on the time-series measurement value, instead of some or all of the feature values or in addition to all of the feature values. The feature value information may be contained in the measurement value information in the injection molding apparatus or the information processing device 20. This is because the information processing device 20 can calculate the one or more types of feature values based on the time-series information. The measurement value information may not include the time-series information as long as including the feature value information. Hereinafter, as an example, a case where the measurement value information includes both the time-series information and the feature value information will be described. The feature value information may be the time-series information. This is also because the information processing device 20 can calculate the one or more types of feature values based on the time-series information.

The one or more pieces of cycle-related information contained in the cycle data of a certain cycle may include other information in addition to the apparatus identification information for identifying the injection molding apparatus as the acquisition source of the cycle data and the one or more pieces of measurement value information. The other information includes, but is not limited to, for example, some or all of cycle identification information for identifying the cycle, operation state information, and product quantity information. Here, the operation state information contained in the cycle data as the cycle-related information is information indicating an operation state of the injection molding apparatus. The product quantity information contained in the cycle data as the cycle-related information is information indicating the number of products injection-molded by the injection molding apparatus in the cycle. The cycle identification information is, for example, information indicating the order in which the cycle is executed in a plurality of cycles that are continuously executed. This is because the cycle can be uniquely specified by combining the information with the first date-and-time information. The cycle identification information may be information by which the cycle can be uniquely identified by the cycle identification information alone, or may be other information by which the cycle can be identified.

The cycle data as described above can be discriminated by the cycle identification information described above, but can also be discriminated by a combination of the apparatus identification information and the first date-and-time information. Therefore, the cycle data may not include the cycle identification information. When there is only one injection molding apparatus coupled to the information processing device 20, the cycle data may not include the apparatus identification information. This is because, in this case, each piece of cycle data can be discriminated simply by the first date-and-time information.

When acquiring certain cycle data, the information processing device 20 stores the acquired cycle data and outputs the acquired cycle data to the server 30. Accordingly, the information processing device 20 can also store the acquired cycle data in the server 30.

Furthermore, the information processing device 20 acquires the injection molding condition data from each of the one or more injection molding apparatuses in the plurality of managed devices 10 at each time when an injection molding condition is set in the injection molding apparatus.

Here, the injection molding condition data acquired from a certain injection molding apparatus is information including one or more pieces of injection molding condition information each indicating the injection molding condition set in the injection molding apparatus, the apparatus identification information for identifying the injection molding apparatus, and second date-and-time information indicating date and time when the injection molding condition data is acquired by the information processing device 20 from the injection molding apparatus. The date and time indicated by the second date-and-time information may be another date and time according to the injection molding condition, such as the date and time when the injection molding condition indicated by each of the one or more pieces of injection molding condition information is set in the injection molding apparatus, instead of the date and time acquired by the information processing device 20 from the injection molding apparatus. The apparatus identification information is, for example, an ID for identifying the injection molding apparatus, and may be other information through which the injection molding apparatus can be identified, such as an IP address assigned to the injection molding apparatus. The second date-and-time information may be a time stamp or other information indicating the date and time. The injection molding condition data may include other information in addition to the one or more pieces of injection molding condition information, the apparatus identification information, and the second date-and-time information. The apparatus identification information may be contained in the injection molding condition data as one of the one or more pieces of injection molding condition information. Hereinafter, as an example, a case where the apparatus identification information is contained in the injection molding condition data as one of the one or more pieces of injection molding condition information will be described.

The one or more pieces of injection molding condition information contained in the injection molding condition data acquired from a certain injection molding apparatus include one or more pieces of target value information in addition to the apparatus identification information for identifying the injection molding apparatus. Each of the one or more pieces of target value information is information indicating one or more target values for each control parameter. Therefore, the target value information indicating one or more target values for a certain control parameter is information indicating the injection molding condition, and is associated with the control parameter. A method of associating the control parameter with the target value information may be a known method or a method to be developed. The reason why the one or more pieces of target value information are contained in the injection molding condition data as the injection molding condition information indicating the injection molding condition is that the injection molding apparatus controls the control parameter such that the value of the control parameter matches the target value of the control parameter for each control parameter in each cycle. Here, the reason why there are one or more target values for each control parameter is that there may be a plurality of target values as targets to which each control parameter is to be brought close in the control by the injection molding apparatus in each cycle. For example, the injection speed as the speed at which the material is injected into the cavity in the mold by the screw changes in a plurality of stages in the injection molding step in each cycle. In this case, there are a plurality of target values for the control parameter. The target value information for a certain control parameter indicates each of one or more target values for the control parameter. Therefore, the injection molding condition data includes, as the injection molding condition information, each of the same number of pieces of target value information as the number of measurement units that measure the measurement values of the control parameters among one or more measurement units attached to the injection molding apparatus. Hereinafter, for convenience of description, each of one or more target values for a certain control parameter will be referred to as a target value corresponding to the control parameter. Therefore, hereinafter, for convenience of description, the control parameter will be referred to as a control parameter corresponding to the one or more target values.

The one or more pieces of injection molding condition information in the injection molding condition data acquired from the certain injection molding apparatus include abnormality determination condition information associated with each target value set as the injection molding condition in the injection molding apparatus, in addition to the apparatus identification information for identifying the injection molding apparatus and the one or more pieces of target value information. The abnormality determination condition information associated with a certain target value is information indicating an abnormality determination condition satisfied by the measurement value of the control parameter when no abnormality occurs in the measurement value of the control parameter in the control to match the measurement value of the control parameter corresponding to the target value with the target value by the injection molding apparatus. A method of associating the target value with the abnormality determination condition information may be a known method or a method to be developed. The abnormality determination condition may be any condition as long as the condition is satisfied by the value of the control parameter when no abnormality occurs in the value of the control parameter in the control.

The one or more pieces of injection molding condition information in the injection molding condition data acquired from a certain injection molding apparatus may include other information in addition to the apparatus identification information for identifying the injection molding apparatus, the one or more pieces of target value information, and the abnormality determination condition information associated with each target value set as the injection molding condition in the injection molding apparatus.

The injection molding condition data as described above can be discriminated by a combination of the apparatus identification information and the second date-and-time information. When there is only one injection molding apparatus coupled to the information processing device 20, the injection molding condition data may not include the apparatus identification information. This is because, in this case, each piece of injection molding condition data can be discriminated simply by the second date-and-time information.

When acquiring certain injection molding condition data, the information processing device 20 stores the acquired injection molding condition data and outputs the acquired injection molding condition data to the server 30. Accordingly, the information processing device 20 can also store the acquired injection molding condition data in the server 30. Here, the information processing device 20 performs the following association in the storage area of the information processing device 20 or the storage area of the server 30. That is, the information processing device 20 associates the injection molding condition data indicating the injection molding conditions set in a certain injection molding apparatus in a certain cycle with the cycle data acquired from the injection molding apparatus in the cycle. Such an association method may be a known method or may be a method to be developed. By the association, at least one piece of injection molding condition data is associated with each piece of cycle data. Hereinafter, as an example, a case where one piece of injection molding condition data is associated with each piece of cycle data will be described.

Here, for example, in each of the information processing device 20 and the server 30, certain cycle data can be associated with injection molding condition data including second date-and-time information indicating date and time closest to the date and time indicated by first date-and-time information among dates and times before the date and time indicated by the first date-and-time information contained in the cycle data. This is because the injection molding condition data includes injection molding condition information indicating the injection molding condition set in the injection molding apparatus in the cycle in which the cycle data is acquired by the information processing device 20. Accordingly, each of the information processing device 20 and the server 30 can specify the injection molding condition set in the injection molding apparatus in the cycle. Therefore, hereinafter, a combination of certain cycle data and injection molding condition data associated with the cycle data will be referred to as output data. That is, the information processing device 20 and the server 30 store the combination as output data. Therefore, the information processing device 20 acquiring each of the cycle data and the injection molding condition data may be interpreted as the information processing device 20 acquiring each of the cycle data and the injection molding condition data as the output data. In the first place, when acquiring the cycle data, the information processing device 20 may acquire, as the output data from the injection molding apparatus, a combination of the cycle data to be acquired and the injection molding condition data including the injection molding condition information indicating the injection molding condition set in the injection molding apparatus at the time of acquiring the cycle data. Note that any format may be used as the storage format of the output data in one or both of the information processing device 20 and the server 30. That is, one or both of the information processing device 20 and the server 30 may be configured to actually store the combination as output data, may be configured to store a correspondence relationship by which the combination can be specified together with one or more pieces of cycle data and one or more pieces of injection molding condition data, or may be configured to specify the combination as necessary. However, in the present embodiment, even when any one of these configurations is implemented, the fact that one or both of the information processing device 20 and the server 30 can specify the combination is referred to as that one or both of the information processing device 20 and the server 30 store the output data.

In response to a request from the terminal device communicably coupled to the information processing device 20, the information processing device 20 displays various images based on the data stored in the information processing device 20 on the display unit of the terminal device. Here, the images include a GUI, an icon, and a window on an operating system (OS). Hereinafter, as an example, a case where the information processing device 20 is communicably coupled to a terminal device 40 as shown in FIG. 1 will be described. In the present embodiment, since processing related to login to the information processing device 20 via the terminal device 40 is known processing, a description thereof will be omitted. Hereinafter, for convenience of description, the information processing device 20 receiving an operation from the terminal device 40 via an image displayed on the terminal device 40 is simply referred to as the information processing device 20 receiving an operation. That is, hereinafter, the information processing device 20 performing certain processing according to a received operation refers to the information processing device 20 performing the processing according to the operation received from the terminal device 40 via the image displayed on the terminal device 40.

Examples of the information processing device 20 include, but are not limited to, a workstation, a desktop personal computer (PC), and a notebook PC. The information processing device 20 is communicably coupled to each of the plurality of managed devices 10 by wired or wireless communication. Examples of the communication network that connects the information processing device 20 and the plurality of managed devices 10 include, but are not limited to, a Local Area Network (LAN) in a facility in which the plurality of managed devices 10 are installed. The communication network may be another communication network such as the Internet or a mobile communication network.

The server 30 stores the cycle data acquired by the information processing device 20. For example, when acquiring certain cycle data from the information processing device 20, the server 30 stores the acquired cycle data.

The server 30 stores the injection molding condition data acquired by the information processing device 20. For example, when acquiring certain injection molding condition data from the information processing device 20, the server 30 stores the acquired injection molding condition data.

In response to a request from a terminal device communicably coupled to the server 30, the server 30 displays various images based on the data stored in the server 30 on the display unit of the terminal device. Here, the images include a GUI, an icon, and a window on an OS. Hereinafter, as an example, a case where the server 30 is communicably coupled to the terminal device 40 as shown in FIG. 1 will be described. In the present embodiment, since processing related to login to the server 30 via the terminal device 40 is known processing, a description thereof will be omitted. Hereinafter, for convenience of description, the server 30 receiving an operation from the terminal device 40 via the image displayed on the terminal device 40 is simply referred to as the server 30 receiving an operation. That is, hereinafter, the server 30 performing certain processing according to a received operation refers to the server 30 performing the processing according to the operation received from the terminal device 40 via the image displayed on the terminal device 40.

As described above, in the molding management system 1, both the information processing device 20 and the server 30 display various images based on the stored data on the display unit of the terminal device 40 according to the received operation. Examples of the display unit include, but are not limited to, a display of the terminal device 40 and a display device communicably coupled to the terminal device 40. Hereinafter, as an example, a case where the display unit is the display of the terminal device 40 will be described. Hereinafter, for convenience of description, displaying a certain image on the display unit is referred to as displaying the image.

Here, in the injection molding by the injection molding apparatus, the quality of the product changes according to changes in the mold, the material used for the injection molding of the product, the environment around the injection molding apparatus, and the like. This is because the optimum injection molding condition for injection molding a high-quality product differs depending on the mold, the material used for injection molding of the product, the environment around the injection molding apparatus, and the like. FIG. 2 is an image diagram of a flow in which the quality of a product injection-molded by the injection molding apparatus changes when the injection molding condition is changed. As shown in FIG. 2, in the injection molding by the injection molding apparatus, when the injection molding condition is changed, the measurement value of the management item changes. As described above, the management item is correlated with the quality of the product. Therefore, when the measurement value of the management item changes, the quality of the product also changes. Such a change in the quality of the product is not necessarily a change for increasing the quality. Therefore, in the related art, a technique of updating the injection molding condition based on a known correlation between the management item and the injection molding condition is known. However, it is known that this technique requires that the correlation between the management item and the injection molding condition should be known in advance, and is applicable only when the correlation is a simple relationship. In order to solve this problem, there is known a method of calculating a response surface having a management item as a response variable and an injection molding condition as an explanatory variable based on cycle data acquired from an injection molding apparatus moment by moment using a model of machine learning or the like, and updating the injection molding condition based on the calculated response surface. However, in the method, the response surface is often calculated based on data including a measurement value deviating from the actual correlation between the management item and the injection molding condition, such as an outlier obtained when the injection molding by the injection molding apparatus is not stable. Thus calculated response surface may not correctly express the correlation between the management item and the injection molding condition. This may make it difficult to obtain a desired injection molding condition, which is not desirable.

Therefore, when a predetermined trigger condition is satisfied, the information processing device 20 reads one or more pieces of output data and excludes output data that satisfies a predetermined exclusion condition from the read one or more pieces of output data. Furthermore, the information processing device 20 calculates a response surface having a measurement value for each of the one or more management items among the one or more measurement values as a response variable and an injection molding condition as an explanatory variable based on the output data remaining without being excluded among the one or more pieces of output data. As shown in FIG. 3, after calculating the response surface, the information processing device 20 derives an acquisition function based on the calculated response surface, calculates a solution that minimizes or maximizes the derived acquisition function, and generates the calculated solution as an injection molding condition. FIG. 3 is an image diagram showing a flow until an injection molding condition is generated from a response surface. For example, the information processing device 20 calculates such a response surface by a model of machine learning. Note that the information processing device 20 may be configured to calculate the response surface by another method that can calculate the response surface. After calculating the response surface, the information processing device 20 generates an injection molding condition based on the calculated response surface. Accordingly, the molding management system 1 can generate an injection molding condition that causes the injection molding apparatus to mold a high-quality product even when the correlation between the management item and the injection molding condition is unknown and complicated. In order to simplify the description, a case where only one injection molding apparatus is coupled to the information processing device 20 will be described below.

### Hardware Configuration of Information Processing Device

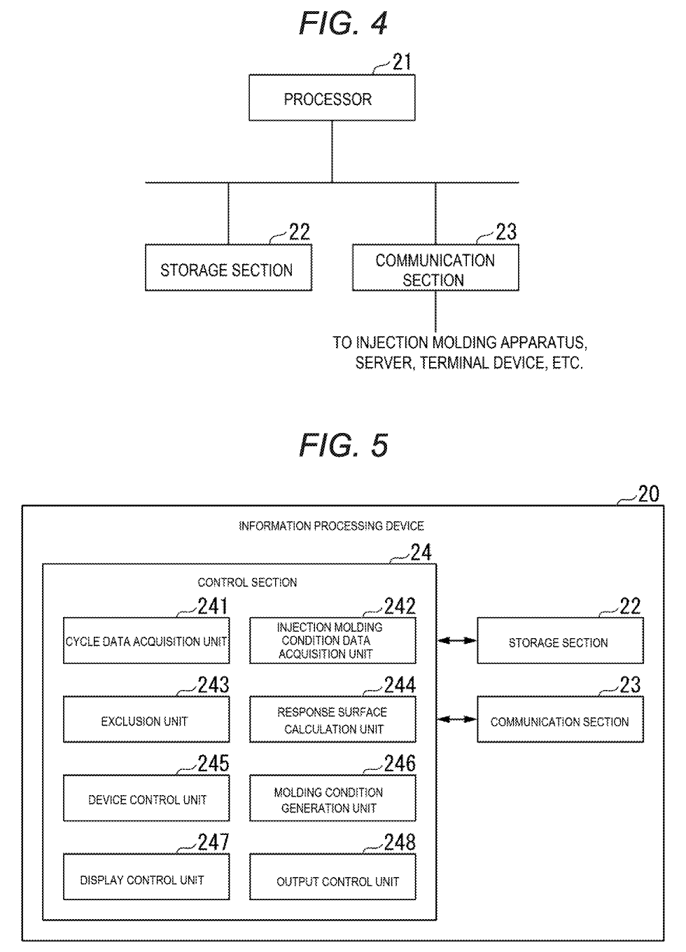

Hereinafter, a hardware configuration of the information processing device 20 will be described with reference to FIG. 4. FIG. 4 shows an example of the hardware configuration of the information processing device 20.

The information processing device 20 includes, for example, a processor 21, a storage section 22, and a communication section 23. These component elements are communicably coupled to one another via a bus. The information processing device 20 communicates with other devices via the communication section 23. The other devices include, for example, an injection molding apparatus, the server 30, the terminal device 40, or the like.

The processor 21 is, for example, a central processing unit (CPU). Instead of the CPU, the processor 21 may be another processor such as a field programmable gate array (FPGA). The processor 21 executes various programs stored in the storage section 22.

The storage section 22 is, for example, a storage device including a hard disk drive (HDD), a solid-state drive (SSD), an electrically erasable programmable read-only memory (EEPROM), a read-only memory (ROM), and a random access memory (RAM). Instead of being built in the information processing device 20, the storage section 22 may be an external storage device coupled to a digital input and output port such as a universal serial bus (USB). The storage section 22 stores various types of information, various images, and various programs to be processed by the information processing device 20. That is, the various types of information stored in the information processing device 20 are stored in the storage section 22. For example, the above-described output data is stored in the storage section 22.

The communication section 23 is a communication device including, for example, a digital input and output port such as a USB, an Ethernet (registered trademark) port, and an antenna for wireless communication.

### Functional Configuration of Information Processing Device

Hereinafter, a functional configuration of the information processing device 20 will be described with reference to FIG. 5. FIG. 5 shows an example of the functional configuration of the information processing device 20.

The information processing device 20 includes the storage section 22, the communication section 23, and a control section 24.

The control section 24 controls the entire information processing device 20. The control section 24 includes at least a cycle data acquisition unit 241, an injection molding condition data acquisition unit 242, an exclusion unit 243, a response surface calculation unit 244, a device control unit 245, a molding condition generation unit 246, a display control unit 247, and an output control unit 248. These functional units provided in the control section 24 are implemented by, for example, the processor 21 executing the various programs stored in the storage section 22. Some or all of the functional units may be hardware functional units such as a large scale integration (LSI) or an application specific integrated circuit (ASIC).

The cycle data acquisition unit 241 acquires the cycle data for each cycle of the injection molding apparatus from the injection molding apparatus communicably coupled to the information processing device 20.

The injection molding condition data acquisition unit 242 acquires the injection molding condition data from the injection molding apparatus communicably coupled to the information processing device 20 at each time when the injection molding condition is set in the injection molding apparatus.

The exclusion unit 243 excludes output data that satisfies a predetermined exclusion condition from one or more pieces of output data read from the storage section 22 or the server 30. The exclusion condition will be described below. Hereinafter, for convenience of description, each of one or more pieces of output data remaining without being excluded by the exclusion unit 243 among one or more pieces of output data read from the storage section 22 or the server 30 will be described as target data. Furthermore, hereinafter, for convenience of description, each piece of output data excluded by the exclusion unit 243 to satisfy the exclusion condition among one or more pieces of output data read from the storage section 22 or the server 30 will be described as excluded data.

The response surface calculation unit 244 calculates a response surface having a measurement value for each of one or more management items among one or more measurement values as a response variable and an injection molding condition as an explanatory variable based on one or more pieces of target data remaining without being excluded by the exclusion unit 243. For example, the response surface calculation unit 244 includes, but is not limited to, a model of machine learning.

The device control unit 245 controls the injection molding apparatus coupled to the information processing device 20 according to a received operation.

The molding condition generation unit 246 generates an injection molding condition based on the response surface calculated by the response surface calculation unit 244.

The display control unit 247 generates various images according to the received operation. The display control unit 247 transmits the generated images to the terminal device 40 and displays the images on the terminal device 40.

The output control unit 248 outputs various types of data to another device according to the received operation.

Processing of Setting Injection Molding Condition in Injection Molding Apparatus by Information Processing Device

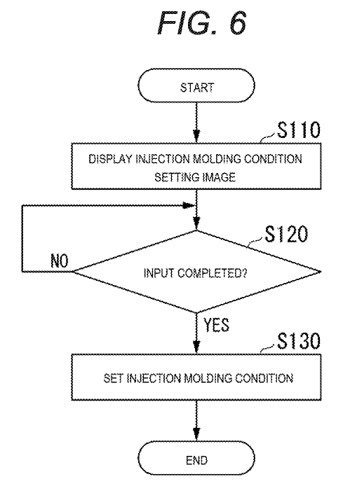

Referring to FIG. 6, processing of setting an injection molding condition in the injection molding apparatus by the information processing device 20 will be described. FIG. 6 shows an example of a flow of processing of setting an injection molding condition in the injection molding apparatus by the information processing device 20. Hereinafter, as an example, a case where an operation of displaying an injection molding condition setting image is received at a timing before the processing in step S110 shown in FIG. 6 is performed will be described. The injection molding condition setting image is an image including an image for receiving various injection molding conditions to be set in the injection molding apparatus coupled to the information processing device 20 and an image for receiving an operation of setting various injection molding conditions received by the image in the injection molding apparatus.

After receiving the operation of displaying the injection molding condition setting image, the display control unit 247 displays the injection molding condition setting image (step S110).

Then, the display control unit 247 waits until input of various injection molding conditions to the injection molding condition setting image is completed (step S120). In FIG. 6, the processing in step S120 is indicated by "INPUT COMPLETED?". Here, for example, when receiving an operation of setting various injection molding conditions received by an image for receiving various injection molding conditions set in the injection molding apparatus coupled to the information processing device 20 in the injection molding apparatus is received via the injection molding condition setting image, the display control unit 247 determines that the input of various injection molding conditions to the injection molding condition setting image is completed. On the other hand, for example, when not receiving the operation via the injection molding condition setting image, the unit determines that the input of various injection molding conditions to the injection molding condition setting image is not completed.

When determining that the input of various injection molding conditions to the injection molding condition setting image is completed (step S120-YES), the display control unit 247 receives the injection molding conditions input to the injection molding condition setting image as the injection molding conditions to be set in the injection molding apparatus, and sets the received injection molding conditions in the injection molding apparatus (step S130). The method of setting the injection molding conditions in the injection molding apparatus by the information processing device 20 may be a known method or a method to be developed. After the processing in step S130 is performed, the information processing device 20 ends the processing of the flowchart shown in FIG. 6.

Here, the injection molding conditions set in the injection molding apparatus by the processing of the flowchart shown in FIG. 6 may be injection molding conditions generated based on the response surface calculated by the information processing device 20, or may be injection molding conditions determined for some other reason.

As described above, the information processing device 20 can set the injection molding condition in the injection molding apparatus according to the received operation.

### Processing of Causing Injection Molding Apparatus to Perform Injection Molding by Information Processing Device

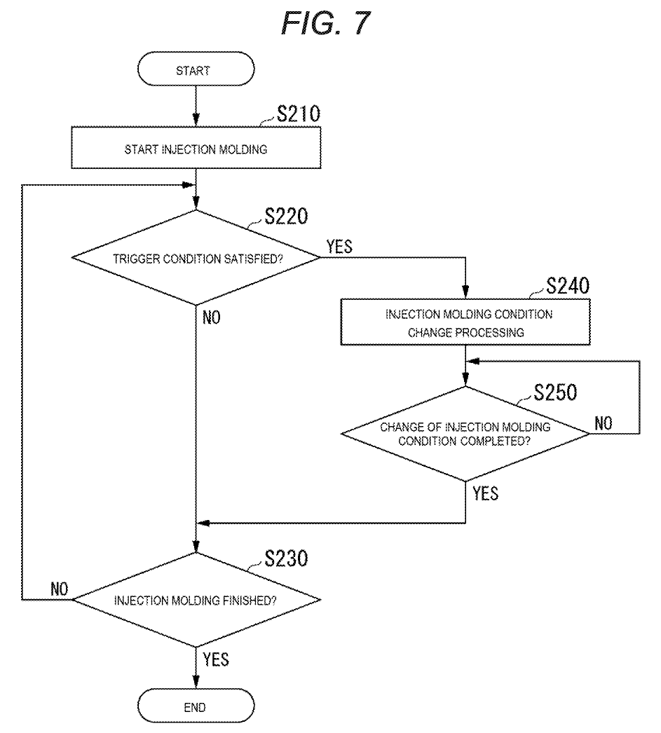

Referring to FIG. 7, processing of causing the injection molding apparatus to perform injection molding by the information processing device 20 will be described. FIG. 7 shows an example of a flow of processing of causing the injection molding apparatus to perform injection molding by the information processing device 20. Hereinafter, as an example, a case where, in order to cause the injection molding apparatus to perform injection molding at a timing before the processing of step S210 shown in FIG. 7 is performed, a cycle execution operation for causing the injection molding apparatus to execute a cycle at the number of cycle executions received in advance as the number of times of execution of the cycle is received will be described.

After receiving the cycle execution operation, the device control unit 245 starts to cause the injection molding apparatus to execute the cycle at the number of cycle executions (step S210). In FIG. 7, the processing in step S210 is indicated by "START INJECTION MOLDING".

Then, the device control unit 245 determines whether a predetermined trigger condition is satisfied (step S220). In FIG. 7, the processing in step S220 is indicated by "TRIGGER CONDITION SATISFIED?". Here, the trigger condition is described. The trigger condition is a condition serving as a trigger to start execution of injection molding condition change processing executed in step S240 described later when the condition is satisfied. The trigger condition is, for example, that one of the measurement values of each of the one or more management items is out of an allowable range determined in advance for each measurement value. However, the allowable range determined in advance for the measurement value of each management item can be determined as a range in which a defective product is produced immediately when the measurement value starts to deviate from the allowable range, but is not generally determined as a range in which a defective product is produced immediately when the measurement value starts to deviate from the allowable range. That is, the allowable range determined in advance for the measurement value of each management item is usually determined such that a defective product is not produced immediately when the measurement value starts to deviate from the allowable range. This means it is possible to cause the injection molding apparatus to continue to set the optimum injection molding condition while preventing production of defective products by changing the injection molding condition set in the injection molding apparatus at each time when the trigger condition is satisfied, which is useful. The trigger condition may be any other condition that can be used as a trigger for starting execution of the injection molding condition change processing when the condition is satisfied.

When determining that the trigger condition is not satisfied (step S220-NO), the device control unit 245 determines whether the cycle at the number of cycle executions started by the injection molding apparatus in step S210 is finished (step S230). In FIG. 7, the processing in step S230 is indicated by "INJECTION MOLDING FINISHED?". Note that the method by which the device control unit 245 performs the processing in step S230 may be a known method or a method to be developed.

When determining that the cycle at the number of cycle executions started by the injection molding apparatus in step S210 is not finished (step S230-NO), the device control unit 245 transitions to step S220 and determines again whether the trigger condition is satisfied.

On the other hand, when determining that the cycle at the number of cycle executions started by the injection molding apparatus in step S210 is finished (step S230-YES), the device control unit 245 ends the processing of the flowchart shown in FIG. 7.

On the other hand, when determining that the trigger condition is satisfied (step S220-YES), the device control unit 245 executes injection molding condition change processing (step S240). Here, the injection molding condition change processing is processing of starting condition setting processing of generating an injection molding condition to be reset in the injection molding apparatus and setting the generated injection molding condition in the injection molding apparatus. The details of the injection molding condition change processing will be described later.

After the processing of step S240 is performed, the device control unit 245 waits until the change of the injection molding condition set in the injection molding apparatus is completed (step S250). Here, in a case where the condition setting processing is started in the injection molding condition change processing, that is, in a case where the injection molding condition generated in the injection molding condition change processing is set in the injection molding apparatus, when the state of the injection molding apparatus is a settable state determined in advance as a state in which the injection molding condition can be set, the device control unit 245 sets the injection molding condition generated in the injection molding condition change processing in the injection molding apparatus. In contrast, in a case where the condition setting processing is started in the injection molding condition change processing, when the state of the injection molding apparatus is not the settable state, the device control unit 245 waits until the state of the injection molding apparatus becomes the settable state. Thereafter, when the state of the injection molding apparatus becomes the settable state, the device control unit 245 sets the injection molding condition generated in the injection molding condition change processing in the injection molding apparatus. Here, the settable state is a state in which the injection molding apparatus does not execute a cycle among the states of the injection molding apparatus. More specifically, the settable state is a state in which the injection molding apparatus does not perform an operation for executing each cycle. In other words, the settable state is a state in which the injection molding apparatus does not use a power engine for performing injection molding, that is, an idling state of the injection molding apparatus. This is realized, for example, in a period or the like from when the injection molding apparatus ends execution of a certain cycle to when the injection molding apparatus starts to execute a cycle to be executed next to the cycle during continuous execution of a plurality of cycles. Due to such circumstances, the information processing device 20 can prevent variations in product quality according to the change in the injection molding condition set in the injection molding apparatus. The device control unit 245 may be configured, when starting the condition setting processing in the injection molding condition change processing, to stop the power engine for the injection molding apparatus to perform injection molding, and set the injection molding condition generated in the injection molding condition change processing in the injection molding apparatus while stopping the power engine. Also in this case, the information processing device 20 can prevent variations in product quality according to the change in the injection molding condition set in the injection molding apparatus.

When determining that the change of the injection molding condition set in the injection molding apparatus is completed (step S250-YES), the device control unit 245 transitions to step S230 and determines again whether the cycle at the number of cycle executions started by the injection molding apparatus in step S210 is finished.

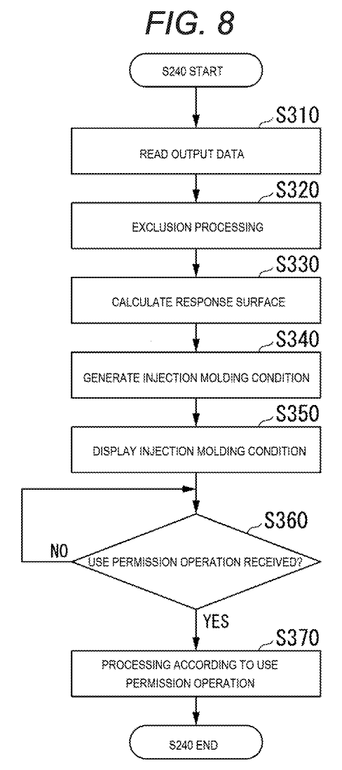

Here, the injection molding condition change processing executed in step S240 shown in FIG. 7 is described with reference to FIG. 8. FIG. 8 shows an example of a flow of injection molding condition change processing executed in step S240 shown in FIG. 7.

The device control unit 245 reads all the output data stored in advance in the storage section 22 from the storage section 22 (step S310). In FIG. 8, the processing in step S310 is indicated by "READ OUTPUT DATA".

Then, the exclusion unit 243 executes exclusion processing (step S320). In FIG. 8, the processing in step S320 is indicated by "EXCLUSION PROCESSING". The exclusion processing is processing of excluding excluded data that satisfies the exclusion condition from the output data read from the storage section 22 by the device control unit 245 in step S310 by the exclusion unit 243. Here, the exclusion condition is described. The exclusion condition is one or more conditions received by the information processing device 20 from the user as conditions for designating excluded data. The exclusion condition is, for example, a condition including at least one of the following conditions.

The output data includes first date-and-time information or second date-and-time information indicating date and time contained in an exclusion period designated by the user.The output data is associated with a flag indicating that the data satisfies the exclusion condition. The output data is associated with information indicating excluded data by the user. The output data includes injection molding condition information indicating an injection molding condition that can be determined to be significantly different from the injection molding condition currently set in the injection molding apparatus. The output data includes mold information indicating a mold different from the mold currently attached to the injection molding apparatus. The output data includes material information indicating a material different from the material currently used for injection molding by the injection molding apparatus. The output data includes cycle data for a cycle executed as purging. The output data is designated as output data to be excluded by the user.

As described above, the exclusion condition is a condition including a condition for excluding the output data including the cycle data acquired from the injection molding apparatus in the cycle executed in a situation where the injection molding is not stable, the output data including the cycle data acquired from the injection molding apparatus in the cycle in which the injection molding is performed under the injection molding condition significantly different from the current injection molding condition, and the like. Each measurement value contained in the output data that satisfies the exclusion condition is often a value required to be treated as an outlier. Accordingly, the information processing device 20 excludes the excluded data from the output data according to the exclusion condition. The exclusion condition may include another condition for designating the excluded data instead of some or all of these conditions or in addition to all of these conditions. Here, for example, when receiving a predetermined operation, the information processing device 20 displays an exclusion condition reception image for receiving an exclusion condition. When the information processing device 20 can receive a plurality of conditions as the exclusion conditions, the information processing device 20 may be configured to display an image different for each condition received as the exclusion condition as the exclusion condition reception image. Therefore, the information processing device 20 receives at least one condition that can be contained in the exclusion condition via one or more exclusion condition reception images.

For example, the information processing device 20 receives the exclusion period via a certain exclusion condition reception image. Accordingly, the information processing device 20 specifies the condition that the output data includes the first date-and-time information or the second date-and-time information indicating the date and time contained in the exclusion period designated by the user as the condition to be contained in the exclusion condition.

For example, the information processing device 20 receives one or more cycles desired by the user among the cycles at the number of cycle executions to be executed by the injection molding apparatus via the exclusion condition reception image. In this case, when the cycle data acquired in the one or more cycles is stored in each of the storage section 22 and the server 30, the information processing device 20 stores a flag indicating that the data satisfies the exclusion condition in association with the cycle data. Furthermore, in this case, when the cycle data acquired in a cycle other than the one or more cycles is stored in each of the storage section 22 and the server 30, the information processing device 20 stores a flag indicating that the exclusion condition is not satisfied in association with the cycle data. Moreover, in this case, for example, the information processing device 20 includes, in the exclusion condition, that the output data is associated with a flag indicating that the data satisfies the exclusion condition with association of the flag indicating that the data satisfies the exclusion condition with the cycle data as a trigger. The information processing device 20 may be configured to omit the association of the flag indicating that the data does not satisfy the exclusion condition with the cycle data.

For example, the information processing device 20 receives the information via the exclusion condition reception image for receiving information indicating one or more cycles to be executed as purging of the cycles at the number of cycle executions to be executed by the injection molding apparatus. In this case, when storing the cycle data of one or more cycles indicated by the information in each of the storage section 22 and the server 30, the information processing device 20 stores the cycle data in association with information indicating the cycle data of the cycle executed as purging. Furthermore, in this case, for example, the information processing device 20 includes, in the exclusion condition, that the output data includes the cycle data of the cycle executed as purging with storage of the cycle data of the one or more cycles in the storage section 22 as a trigger. The information indicating one or more cycles to be executed as purging of the cycles at the number of cycle executions to be executed by the injection molding apparatus may be the number of times of purging. In this case, the information processing device 20 associates information indicating the cycle data of the cycle executed as purging with the cycle data of the cycles at the received number of times of purging in order from the cycle executed first among the cycles at the number of cycle executions.

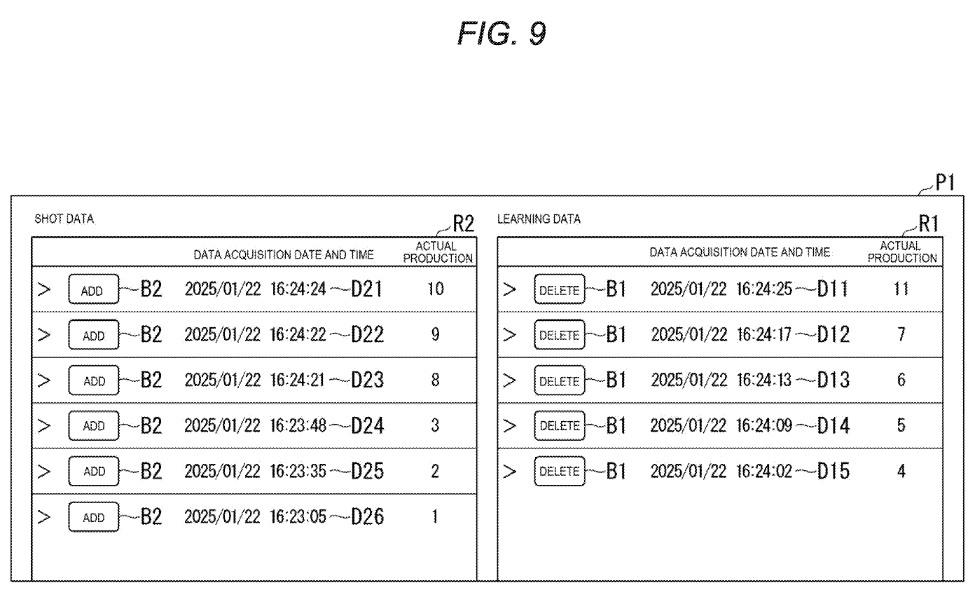

For example, the information processing device 20 receives one or more pieces of output data via an exclusion condition reception image for designating the one or more pieces of output data to be excluded by the user. Here, FIG. 9 shows an example of an exclusion condition reception image for designating one or more pieces of output data to be excluded by the user. An image P1 shown in FIG. 9 shows the example of the exclusion condition reception image. The image P1 includes, for example, a region R1 and a region R2. The image P1 may include another GUI in addition to these two regions.

The region R1 is a region in which output data information indicating each piece of output data not designated as output data to be excluded by the user among pieces of output data information indicating one or more pieces of output data stored in the storage section 22 or the server 30 is displayed. Here, in the example shown in FIG. 9, certain output data information is information indicating the output data by information with which the cycle of the cycle data contained in the output data indicated by the output data information can be identified and the first date-and-time information contained in the cycle data. Furthermore, in this example, the information with which the cycle of the cycle data contained in the output data indicated by the output data information includes, but is not limited to, the cycle identification information described above. In FIG. 9, the information is indicated by "ACTUAL PRODUCTION". In this example, the total number of one or more pieces of output data stored in the storage section 22 or the server 30 is 11. In the region R1, output data information indicating five pieces of output data among the eleven pieces of output data is displayed. Each of the output data information D11 to the output data information D15 shown in FIG. 9 is an example of output data information indicating output data not designated as output data to be excluded by the user among the output data information indicating each of one or more pieces of output data stored in the storage section 22 or the server 30. A button B1 is displayed in association with each of the output data information D11 to the output data information D15. The button B1 is a button displayed in association with each piece of output data information displayed in the region R1, and is a button for receiving an operation of designating output data indicated by the associated output data information as output data to be excluded. For example, when a selection operation is performed on the button B1 displayed in association with the output data information D11, the information processing device 20 specifies the output data indicated by the output data information D11 as the output data to be excluded by the user. Then, the information processing device 20 moves the output data information D11 from the region R1 to a region R2 described later. In the present embodiment, the selection operation includes, but is not limited to, a click and a tap.

The region R2 is a region in which output data information indicating each piece of output data designated as output data to be excluded by the user among pieces of output data information indicating one or more pieces of output data stored in the storage section 22 or the server 30 is displayed. In the region R2, output data information indicating six pieces of output data designated by the user as output data to be excluded is displayed. In FIG. 9, these six pieces of output data are shown as output data information D21 to output data information D26. That is, the six pieces of output data information of the output data information D21 to the output data information D26 are output data information displayed in the region R2 as a result of the selection operation performed on the buttons B1 displayed in association in the region R1. The output data indicated by each of the six pieces of output data information is an example of the output data designated by the user as the output data to be excluded. A button B2 is displayed in association with each of the output data information D21 to the output data information D26. The button B2 is a button displayed in association with each piece of output data information displayed in the region R2, and is a button for receiving an operation of removing designation of output data indicated by the associated output data information as output data to be excluded. For example, when a selection operation is performed on the button B2 displayed in association with the output data information D21, the information processing device 20 re-specifies the output data indicated by the output data information D21 as output data not to be excluded by the user. Then, the information processing device 20 moves the output data information D21 from the region R2 to the region R1 described above.

The information processing device 20 specifies the output data designated as one or more pieces of output data to be excluded by the user via the image P1 having the above-described configuration. Accordingly, the information processing device 20 can easily sort the stored output data into either the target data or the excluded data. Furthermore, the information processing device 20 includes, in the exclusion condition, that the one or more pieces of output data are output data designated as output data to be excluded by the user with designation as output data to be excluded as a trigger.

The configurations of the various exclusion condition reception images described above are merely examples, and other configurations may be used. That is, the exclusion condition reception image may be any image as long as the image can receive a condition to be contained in the exclusion condition. In the present embodiment, receiving a certain condition as a condition to be contained in the exclusion condition includes receiving a trigger for performing processing of including the certain condition in the exclusion condition.

Note that the processing in step S310 and the processing in step S320 may be combined. That is, the information processing device 20 may be configured to read the output data after exclusion of the excluded data that satisfies the exclusion condition from the storage section 22 as the target data in the step in which step S310 and step S320 are combined. The information processing device 20 may be configured not to store the output data that satisfies the exclusion condition in the storage section 22 and the server 30 at the stage of storing the output data in the storage section 22 and the server 30. In this case, the information processing device 20 may be configured to omit step S320. Furthermore, in this case, in order to leave the history of the output data that has not been stored, the output data satisfying the exclusion condition may not be stored in the storage section 22, and all the output data may be stored in the server 30 regardless of whether the exclusion condition is satisfied.

After the processing in step S320 is performed, the response surface calculation unit 244 calculates a response surface based on the target data remaining after the excluded data is excluded in step S320 among the output data read in step S310 (step S330). Here, the processing in step S330 is described in detail.

In step S330, the response surface calculation unit 244 calculates a response surface with the measurement value for each of one or more management items among one or more measurement values indicated by the measurement value information of the cycle data contained in the target data as a response variable and the injection molding condition indicated by the injection molding condition information of the injection molding condition data contained in the target data as an explanatory variable. The response surface calculation unit 244 calculates the response surface by a machine learning model using a predetermined optimization algorithm. Such a machine learning model has, for example, an injection molding condition as an explanatory variable and a difference between a measurement value and a target value of a management item as an objective function. The objective function may be a least square error or an absolute value of the difference. The explanatory variable may include a parameter related to the management item. The algorithm includes, but is not limited to, for example, a Bayesian optimization algorithm. Here, the machine learning model using the Bayesian optimization algorithm is often a non-parametric probabilistic model. As is well known, in the non-parametric probabilistic model, it is not necessary to determine the function form of a fitting function in advance, and as a result, it is not necessary to perform modeling of the injection molding apparatus to be controlled, control modeling for control of management items according to injection molding conditions, and the like at the stage before the injection molding apparatus is caused to execute a cycle. This is useful because the preparation for calculating the response surface can be greatly reduced. In addition, when a non-parametric probability model is adopted as the machine learning model, the information processing device 20 can easily calculate the response surface even when the measurement value of the management item returns a complicated response according to a change in the injection molding condition. When the measurement value of the management item returns a complicated response according to a change in the injection molding condition, in the related art, a person manually adjusts the optimum injection molding condition by trial and error. The information processing device 20 can prevent such a trial-and-error from being performed, and can reduce the burden on the user. Note that returning a complicated response of the measurement value of the management item according to a change in the injection molding condition often occurs in a complicated phenomenon such as a multi-purpose, multivariate, or non-linear phenomenon. That is, the information processing device 20 can easily calculate a response surface with which an optimum injection molding condition can be calculated even in injection molding with a complex phenomenon such as a multi-purpose, multivariate, or non-linear phenomenon. The above-described control modeling is, for example, gain design in PID control, derivation of an equation of state in model predictive control, and the like.

For example, the response surface calculation unit 244 inputs a response variable as a measurement value for each of one or more management items and an explanatory variable as an injection molding condition in association with each other to the machine learning model described above, and acquires a response surface output from the machine learning model. Here, the machine learning model may be a non-parametric probabilistic model such as a Gaussian process regression model that is often used in Bayesian optimization, or may be a decision model that is not a probabilistic model.

After the processing in step S330 is performed, the molding condition generation unit 246 generates an injection molding condition based on the response surface calculated in step S330 (step S340). Here, for example, the molding condition generation unit 246 derives an acquisition function from the response surface, and generates a solution that minimizes or maximizes the derived acquisition function as a new injection molding condition to be set in the injection molding apparatus. Examples of the acquisition function include, but are not limited to, expected improvement (EI), upper confidence bounds (UCB), and probability of improvement (PI) that are often used in Bayesian optimization. The molding condition generation unit 246 may be configured to generate the injection molding condition based on the response surface by another method.

Then, the display control unit 247 generates a use permission image including information indicating the injection molding condition generated in step S340 and an operation reception image for receiving an operation indicating whether to use the injection molding condition as an injection molding condition to be newly set in the injection molding apparatus, and displays the generated use permission image (step S350). Here, the use permission image may be any image as long as the image includes the information and the operation reception image.

The device control unit 245 waits until an operation on the operation reception image of the use permission image displayed in step S350 is received (step S360). In FIG. 8, the processing in step S360 is indicated by "USE PERMISSION OPERATION RECEIVED?".

When it is determined that the operation on the operation reception image of the use permission image displayed in step S350 is received (step S360-YES), the device control unit 245 performs processing according to the operation received via the operation reception image (step S370), and ends the processing of the flowchart shown in FIG. 8. For example, in step S370, when receiving an operation indicating that the injection molding condition generated in step S340 is not used as an injection molding condition to be newly set in the injection molding apparatus via the operation reception image, the device control unit 245 discards the injection molding condition generated in step S340, and ends the processing of the flowchart shown in FIG. 8. In this case, the injection molding apparatus continues the execution of the cycle under the injection molding condition originally set, and in the flowchart shown in FIG. 7, omits step S250 and transitions to step S230. On the other hand, for example, in step S370, when receiving an operation indicating that the injection molding condition generated in step S340 is used as an injection molding condition to be newly set in the injection molding apparatus via the operation reception image, the device control unit 245 starts condition setting processing of setting the injection molding condition generated in step S340 in the injection molding apparatus, and ends the processing of the flowchart shown in FIG. 8.

By the processing as described above, the information processing device 20 can generate an injection molding condition that causes the injection molding apparatus to mold a high-quality product even when the correlation between the management item and the injection molding condition is unknown and complicated. As a result, the information processing device 20 can cause the injection molding apparatus to perform injection molding while updating the injection molding condition set in the injection molding apparatus according to the situation.

Note that the information processing device 20 may be configured to omit the processing in step S350 and step S360 in the processing of the flowchart shown in FIG. 8. In this case, in step S370, the information processing device 20 starts condition setting processing of setting the injection molding conditions generated in step S340 in the injection molding apparatus. Accordingly, the information processing device 20 can automatically maintain the injection molding condition set in the injection molding apparatus at the optimum injection molding condition without bothering a person.

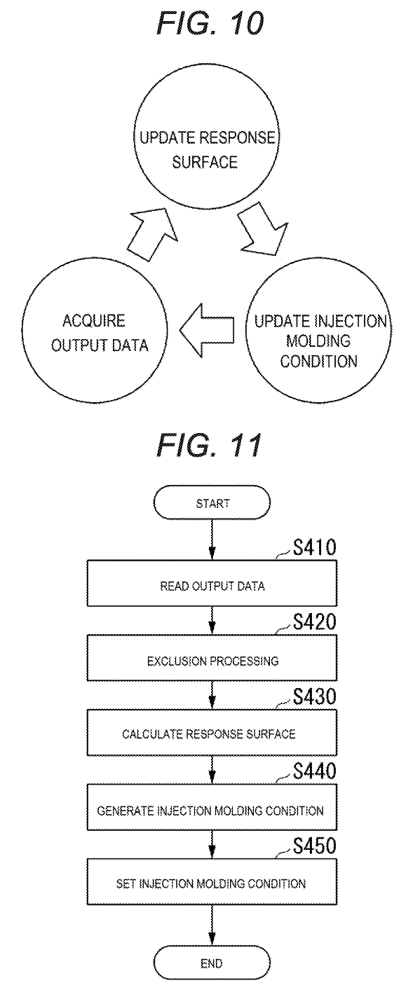

Furthermore, the information processing device 20 can automatically and cyclically repeat the acquisition of the output data from the injection molding apparatus, the update of the response surface calculated by the information processing device 20, and the update of the injection molding condition set in the injection molding apparatus in order as shown in FIG. 10 in the continuous execution of the cycle at the number of cycle executions by the injection molding apparatus through the processing of the flowcharts shown in FIGS. 7 and 8. FIG. 10 is a schematic diagram showing an image of processing performed by the information processing device 20 in continuous execution of the cycle at the number of cycle executions by the injection molding apparatus. In the cyclic update of the injection molding condition shown in FIG. 10, for example, a plurality of management items received before the injection molding apparatus starts the injection molding of the product can be simultaneously adjusted by a plurality of injection molding conditions without stopping the continuous execution of the cycle by the injection molding apparatus in the middle. This leads to an increase in efficiency of injection molding by the injection molding apparatus, and as a result, for example, an increase in the production quantity of trial parts, a decrease in production efficiency, and the like can be prevented, which is useful.

### Processing of Generating Injection Molding Condition to be First Set in Injection Molding Apparatus by Information Processing Device

The information processing device 20 updates the injection molding condition by the processing of the flowcharts shown in FIGS. 7 and 8 for the injection molding apparatus in which the injection molding condition received via the injection molding condition setting image is set. That is, the information processing device 20 does not generate the injection molding condition to be first set in the injection molding apparatus by the processing. The injection molding condition first set in the injection molding apparatus is an injection molding condition obtained by some method such as a simulation or a method based on past experience. However, for example, when the type, shape, and the like of the product to be injection-molded by the injection molding apparatus from now on are the same or similar to the type, shape, and the like of the product injection-molded by the injection molding apparatus in the past, and the environment or the like in which the injection molding apparatus performs the injection molding is the same or similar to the environment or the like in which the injection molding apparatus performs the injection molding in the past, it is considered that the injection molding condition first set in the injection molding apparatus is close to the injection molding condition set in the injection molding apparatus in the past. Therefore, in this case, the information processing device 20 can also generate the injection molding condition to be first set in the injection molding apparatus by the response surface.

Hereinafter, processing of generating an injection molding condition to be first set in the injection molding apparatus by the information processing device 20 will be described with reference to FIG. 11. FIG. 11 shows an example of a flow of processing of generating an injection molding condition to be first set in the injection molding apparatus by the information processing device 20. Note that the injection molding condition to be first set in the injection molding apparatus refers to an injection molding condition to be set in the injection molding apparatus on standby at a stage before the continuous execution of the cycle at the number of cycle executions for injection molding of a certain type of product is started. In other words, the injection molding condition first set in the injection molding apparatus refers to an injection molding condition to be set in the injection molding apparatus on standby at a stage before mass production of a certain type of product is started.

The device control unit 245 reads all the output data stored in advance in the storage section 22 from the storage section 22 (step S410). In FIG. 11, the processing in step S410 is indicated by "READ OUTPUT DATA".

Then, the exclusion unit 243 executes exclusion processing (step S420). In FIG. 11, the processing in step S420 is indicated by "EXCLUSION PROCESSING". Here, the exclusion condition used by the exclusion unit 243 in step S420 is required to be an exclusion condition received in advance by the information processing device 20, and an exclusion condition for excluding output data other than the output data including the cycle data for the injection molding of the products having the same or similar type, shape, and the like of the product to be injection-molded by the injection molding apparatus. Furthermore, the exclusion condition used by the exclusion unit 243 in step S420 is required to be an exclusion condition received in advance by the information processing device 20, and an exclusion condition for excluding output data other than output data including cycle data acquired in a cycle executed in the same or similar environment or the like as or to the environment or the like in which the current injection molding apparatus performs injection molding. Therefore, the information processing device 20 is required to receive the exclusion condition satisfying these conditions from the user in advance. The exclusion unit 243 may be configured to exclude output data other than the output data satisfying these conditions from the output data read in step S410 using, for example, a machine learning model, generation artificial intelligence (AI), or the like. In this case, instead of receiving the exclusion condition, the information processing device 20 receives, for example, information indicating the type, shape, and the like of the product to be injection-molded by the injection molding apparatus, information indicating the environment in which the current injection molding apparatus performs injection molding, and the like.

Note that the processing of step S410 and the processing of step S420 may be combined. That is, the information processing device 20 may be configured to read the output data after exclusion of the excluded data that satisfies the exclusion condition from the storage section 22 as the target data in the step in which step S410 and step S420 are combined.

Then, the response surface calculation unit 244 calculates a response surface based on the target data remaining after the excluded data is excluded in step S420 among the output data read in step S410 (step S430).

Then, the molding condition generation unit 246 generates an injection molding condition based on the response surface calculated in step S430 (step S440).

Then, the device control unit 245 starts condition setting processing of setting the injection molding condition generated in step S440 in the injection molding apparatus, and ends the processing of the flowchart shown in FIG. 11.

As described above, the information processing device 20 can generate the injection molding condition to be first set in the injection molding apparatus based on the response surface. Accordingly, the information processing device 20 can generate an injection molding condition that causes the injection molding apparatus to mold a high-quality product from the start even when the correlation between the management item and the injection molding condition is unknown and complicated.

The molding management system 1 described above may include the terminal device 40. The molding management system 1 described above may include an injection molding apparatus such as the injection molding apparatus 11.

The detailed configurations described above may be combined in any manner.

### Appendices

A molding management system includes an information processing device communicably coupled to a terminal device for management of production of a product in a production process including an injection molding step of the product by an injection molding apparatus, wherein the information processing device acquires output data output from the injection molding apparatus for each cycle of injection molding performed by the injection molding apparatus, the output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus, the one or more measurement values include a measurement value for each of one or more management items correlated with quality of the product, and when a predetermined trigger condition is satisfied, the information processing device excludes the output data that satisfies an exclusion condition from one or more pieces of the output data acquired from the injection molding apparatus, calculates a response surface with the measurement value of each of the one or more management items among the one or more measurement values as a response variable and the injection molding condition as an explanatory variable based on the output data remaining without being excluded among the one or more pieces of the output data, and changes the injection molding condition set in the injection molding apparatus based on the calculated response surface.

In the molding management system according to [1], the information processing device causes a display unit to display an exclusion condition reception image for receiving the exclusion condition according to a received operation.

In the molding management system according to [1] or [2], the output data is associated with a flag indicating whether the data satisfies the exclusion condition, the exclusion condition is that the output data is indicated by the flag as being the data that satisfies the exclusion condition, and the information processing device acquires the injection molding condition data including the injection molding condition information indicating the injection molding condition after a change from the injection molding apparatus and stores the acquired injection molding condition data in a storage unit at each time when the injection molding condition set in the injection molding apparatus is changed, acquires the cycle data from the injection molding apparatus for each cycle and stores the acquired cycle data in the storage unit in association with one of the flag indicating the data that satisfies the exclusion condition and the flag indicating the data that does not satisfy the exclusion condition based on a determination condition received in advance, associates the cycle data and the injection molding condition data stored in the storage unit as the output data, and displays a determination condition reception image for receiving the determination condition on a display unit and receives the determination condition via the determination condition reception image according to a received operation.

In the molding management system according to [3], the determination condition includes that the cycle data is output from the injection molding apparatus in the cycle executed as purging among a plurality of the cycles executed continuously, and the determination condition reception image includes an image for receiving information indicating the cycle executed as purging among the plurality of cycles executed continuously.

In the molding management system according to [4], the information indicating the cycle executed as purging among the plurality of cycles executed continuously is a number of times of purging.

In the molding management system according to any one of [1] to [5], the information processing device generates the injection molding condition set in the injection molding apparatus based on the calculated response surface, displays the generated injection molding condition on a display unit, displays, on the display unit, a use permission image for receiving an operation indicating whether to use the injection molding condition displayed on the display unit, and when receiving the operation indicating to use the injection molding condition displayed on the display unit via the use permission image, changes the injection molding condition set in the injection molding apparatus by setting the injection molding condition displayed on the display unit in the injection molding apparatus.

In the molding management system according to [6], in a case of setting the injection molding condition displayed on the display unit in the injection molding apparatus, the information processing device sets the injection molding condition displayed on the display unit in the injection molding apparatus when a state of the injection molding apparatus is a settable state determined in advance as a state in which the injection molding condition is settable, waits until the state of the injection molding apparatus becomes the settable state when the state of the injection molding apparatus is not the settable state, and then, sets the injection molding condition displayed on the display unit in the injection molding apparatus when the state of the injection molding apparatus becomes the settable state.

In the molding management system according to any one of [1] to [7], the information processing device calculates the response surface using a predetermined optimization algorithm.

In the molding management system according to [8], the algorithm is a Bayesian optimization algorithm.

The molding management system according to any one of [1] to [9], further includes the terminal device.

The molding management system according to any one of [1] to , further includes the injection molding apparatus.

The embodiments of the present disclosure are described in detail above with reference to the drawings. However, specific configurations are not limited to the embodiments and may be, for example, changed, replaced, or deleted without departing from the gist of the present disclosure.

A program for implementing the function of any component in the device described above may be recorded in a computer-readable storage medium and the program may be loaded and executed in a computer system. Here, the device is, for example, the injection molding apparatus 11, the information processing device 20, the server 30, or the terminal device 40. The "computer system" referred to here includes an operating system (OS) and hardware such as peripheral devices. The "computer-readable storage medium" refers to a portable medium such as a flexible disc, a magneto-optical disc, a ROM, or a compact disk (CD) ROM or a storage device such as a hard disk built in the computer system. Furthermore, the "computer-readable storage medium" includes a medium that stores the program for a certain period of time, such as a volatile memory inside the computer system serving as a server or a client when the program is transmitted via a network such as the Internet or a communication line such as a telephone line.

The program may be transmitted from a computer system in which the program is stored in a storage device or the like to another computer system via a transmission medium or a transmission wave in the transmission medium. Here, the "transmission medium" for transmitting the program refers to a medium having a function of transmitting information like a network such as the Internet or a communication line such as a telephone line.

The program may be a program for implementing part of the functions described above. Furthermore, the program may be a so-called differential file or differential program that can implement the functions described above in combination with a program already recorded in the computer system.

What is claimed is:

1. A molding management system comprising an information processing device communicably coupled to a terminal device for management of production of a product in a production process including an injection molding step of the product by an injection molding apparatus, wherein
the information processing device acquires output data output from the injection molding apparatus for each cycle of injection molding performed by the injection molding apparatus,
the output data is data in which cycle data including measurement value information indicating each of one or more measurement values measured in the injection molding apparatus in response to execution of the cycle by the injection molding apparatus is associated with injection molding condition data including injection molding condition information indicating an injection molding condition set in the injection molding apparatus,
the one or more measurement values include a measurement value for each of one or more management items correlated with quality of the product, and
when a predetermined trigger condition is satisfied, the information processing device excludes the output data that satisfies an exclusion condition from one or more pieces of the output data acquired from the injection molding apparatus, calculates a response surface with the measurement value of each of the one or more management items among the one or more measurement values as a response variable and the injection molding condition as an explanatory variable based on the output data remaining without being excluded among the one or more pieces of the output data, and changes the injection molding condition set in the injection molding apparatus based on the calculated response surface.

2. The molding management system according to claim 1, wherein
the information processing device causes a display unit to display an exclusion condition reception image for receiving the exclusion condition according to a received operation.

3. The molding management system according to claim 1, wherein
the output data is associated with a flag indicating whether the data satisfies the exclusion condition,
the exclusion condition is that the output data is indicated by the flag as being the data that satisfies the exclusion condition, and
the information processing device acquires the injection molding condition data including the injection molding condition information indicating the injection molding condition after a change from the injection molding apparatus and stores the acquired injection molding condition data in a storage unit at each time when the injection molding condition set in the injection molding apparatus is changed, acquires the cycle data from the injection molding apparatus for each cycle and stores the acquired cycle data in the storage unit in association with one of the flag indicating the data that satisfies the exclusion condition and the flag indicating the data that does not satisfy the exclusion condition based on a determination condition received in advance, associates the cycle data and the injection molding condition data stored in the storage unit as the output data, and displays a determination condition reception image for receiving the determination condition on a display unit and receives the determination condition via the determination condition reception image according to a received operation.

4. The molding management system according to claim 3, wherein
the determination condition includes that the cycle data is output from the injection molding apparatus in the cycle executed as purging among a plurality of the cycles executed continuously, and
the determination condition reception image includes an image for receiving information indicating the cycle executed as purging among the plurality of cycles executed continuously.

5. The molding management system according to claim 4, wherein
the information indicating the cycle executed as purging among the plurality of cycles executed continuously is a number of times of purging.

6. The molding management system according to claim 1, wherein
the information processing device generates the injection molding condition set in the injection molding apparatus based on the calculated response surface, displays the generated injection molding condition on a display unit, displays, on the display unit, a use permission image for receiving an operation indicating whether to use the injection molding condition displayed on the display unit, and when receiving the operation indicating to use the injection molding condition displayed on the display unit via the use permission image, changes the injection molding condition set in the injection molding apparatus by setting the injection molding condition displayed on the display unit in the injection molding apparatus.

7. The molding management system according to claim 6, wherein
in a case of setting the injection molding condition displayed on the display unit in the injection molding apparatus, the information processing device sets the injection molding condition displayed on the display unit in the injection molding apparatus when a state of the injection molding apparatus is a settable state determined in advance as a state in which the injection molding condition is settable, waits until the state of the injection molding apparatus becomes the settable state when the state of the injection molding apparatus is not the settable state, and then, sets the injection molding condition displayed on the display unit in the injection molding apparatus when the state of the injection molding apparatus becomes the settable state.

8. The molding management system according to claim 1, wherein
the information processing device calculates the response surface using a predetermined optimization algorithm.

9. The molding management system according to claim 8, wherein
the algorithm is a Bayesian optimization algorithm.

10. The molding management system according to claim 1, further comprising the terminal device.

11. The molding management system according to claim 1, further comprising the injection molding apparatus.
